(19) United States
(12) Patent Application Publication
(10) Pub. No.: US 2018/0160199 A1
(43) Pub. Date: Jun. 7, 2018

(54) AUDIENCE DRIVEN INTERACTIVE PLOT CONTROL

(71) Applicant: The DIRECTV Group, Inc., EI Segundo, CA (US)

(72) Inventor: Erich John Kring, Torrance, CA (US)

(21) Appl. No.: 15/370,628

(22) Filed: Dec. 6, 2016

(51) Int. Cl. H04N 21/8545; H04N 21/4788; H04L 29/06; H04N 21/2187; H04N 21/431; H04N 21/488; H04N 21/81; H04N 21/234; H04L 9/06

(52) U.S. Cl. CPC H04N 21/8545; H04N 21/4788; H04L 65/60; H04N 21/2187; H04L 9/0643; H04N 21/4882; H04N 21/812; H04N 21/23424; H04N 21/431

(57) ABSTRACT

Passive audiences are enabled to become active participants in plot choices made by characters in audio/visual broadcast events are provided. A method can comprise downloading, to a user device, an initial section of broadcast audiovisual content and an index representing subsequent subsections of the broadcast audiovisual content, and facilitating display of a prompt as a function of the index. Further, based on a reply, received from the user device in response to the prompt, the method can comprise downloading a subsequent subsection of the subsequent subsections for display by the user device.

### TECHNICAL FIELD

The disclosed subject matter provides systems and methods that enable passive audiences to become active participants in plot choices made by characters in audio/visual broadcast events.

### BACKGROUND

Currently, audience members to a broadcast audio/visual event are passive participants in their television entertainment experiences. They are unable to affect the course of events in the audio/visual event. Audience members are unable to explore the full panoply of feasible/foreseeable eventualities in the broadcast audio/visual event that they might find interesting. For example, in a broadcast television novella, audience members are currently unable to explore alternative possibilities, such as would the ultimate outcome to the heroine, Harlyn, of living in unhappy penury, have been altered had she opted to accept the advances of earnest but slow witted Alphonso rather than those of brazen and fast talking Mustachio? Had Harlyn married Alphonso, rather than Mustachio, would Alphonso have still have become the world's first Trillionaire, since Harlyn is incapable of keeping confidences?

### BRIEF DESCRIPTION OF DRAWINGS

FIG. 1 is an illustration of a system that enables passive audiences to become active participants in plot choices made by characters in audio/visual broadcast events, in accordance with aspects of the subject disclosure.

FIG. 2 is a further depiction of a further system that enables passive audiences to become active participants in plot choices made by characters in audio/visual broadcast events, in accordance with aspects of the subject disclosure.

FIG. 3 provides illustration of an additional system that enables passive audiences to become active participants in plot choices made by characters in audio/visual broadcast events, in accordance with aspects of the subject disclosure.

FIG. 4 provides another illustration of a system that enables passive audiences to become active participants in plot choices made by characters in audio/visual broadcast events, in accordance with aspects of the subject disclosure.

FIG. 5 provides illustration of a flow chart or method for enabling passive audiences to become active participants in plot choices made by characters in audio/visual broadcast events, in accordance with aspects of the subject disclosure.

FIG. 6 provides illustration of an additional flow chart or method for enabling passive audiences to become active participants in plot choices made by characters in audio/visual broadcast events, in accordance with aspects of the subject disclosure.

FIG. 7 provides illustration of another flow chart or method for enabling passive audiences to become active participants in plot choices made by characters in audio/visual broadcast events, in accordance with aspects of the subject disclosure.

FIG. 8 provides additional illustration of a flow chart or method for enabling passive audiences to become active participants in plot choices made by characters in audio/visual broadcast events, in accordance with aspects of the subject disclosure.

FIG. 9 is a block diagram of an example embodiment of a mobile network platform to implement and exploit various features or aspects of the subject disclosure.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

It should be realized and appreciated by those of ordinary skill that the foregoing non-limiting example application is merely an illustration of a use of the disclosed and described solution and is provided only for the purposes of exposition. The described and disclosed subject matter is therefore not limited to the foregoing example application, but can find applicability in other more generalized circumstances and use applications.

The disclosed systems and methods, in accordance with an embodiment, provide a system, apparatus, or device comprising: downloading, to a user device, an initial section of broadcast audiovisual content and an index representing subsequent subsections of the broadcast audiovisual content; facilitating display of a prompt as a function of the index; and based on a reply, received from the user device in response to the prompt, downloading a subsequent subsection of the subsequent subsections for display by the user device.

The prompt can represent a plot device that furthers the broadcast audiovisual content from the initial section to the subsequent subsection of the subsequent subsections of the broadcast audiovisual content, wherein the prompt representing the plot device can be displayed as a function of a defined time period being exceeded. Further, in embodiments, the prompt representing the plot device can be displayed in response to an elapse of time exceeding a threshold value; during a scheduled commercial intermission during streaming of the broadcast audiovisual content; at a commencement of a scheduled commercial intermission during streaming of the broadcast audiovisual content; at a conclusion of a scheduled commercial intermission during streaming of the broadcast audiovisual content; or when the prompt representing the plot device is a second prompt, the prompt can be displayed as a function of an elapse of a defined time period since displaying the first prompt representing a previous plot device associated with the broadcast audiovisual content.

The index can represent a value obtained by applying a hash function to each subsequent subsection of the subsequent subsections of broadcast content, the hash function can be a cryptographic hash function that generates a unique value; and/or a format preserving cryptographic function that generates a unique value.

Additional operations can comprise, in a response to the prompt from an audience member, receiving an index value representative of the subsequent subsection of the subsequent subsections of the broadcast audiovisual content, wherein the index value represents a branch of a hierarchy of branches associated with the subsection of subsequent subsections of the broadcast audiovisual content.

In accordance with a further embodiment, the subject disclosure describes a method, comprising a series of acts that can include: streaming, to a remote device comprising a display device and storage devices. an initial section of an event broadcast in real time and an index representing subsequent subsections of the event; facilitating display of a prompt, on the display device, as a function of the index; and based on a reply, received from a user device in response to the prompt, streaming a subsequent subsection of the subsequent subsections of the event.

In accordance with a still further embodiment, the subject disclosure describes a machine readable storage medium, a computer readable storage device, or non-tangible machine readable media comprising instructions that, in response to execution, cause a computing system comprising at least one processor to perform operations. The operations can include: streaming an initial section of a live event broadcast and an index representing subsequent subsections of the live event; facilitating display of a prompt as a function of the index; and based on a reply, received from a user device in response to the prompt, streaming a subsequent subsection of the subsequent subsections of the live event.

The subject disclosure describes systems and methods that enable passive audiences to become active participants in plot choices made by characters in an audio/visual broadcast event (e.g. live or prerecorded). By preloading all (or a portion thereof in order to conserve system memory) plot and subplot branches and sub-branches of an audio/visual broadcast event to a persistence device, the audio/visual broadcast event can be made interactive; as different distinguishable plot/subplot branches/sub-branches can be selected depending on user preference(s) or user choices(s). This enables the user (or users, if multiple inputs are being aggregated to choose a unique plot/subplot branch or sub-branch) to play and replay the audio/visual broadcast event multiple times to experience a plethora of disparate outcomes and/or allows the user to play and replay the audio/visual broadcast event multiple times to conclude at a same eventuality, but through alternative and/or additional plots and/or subplots. When multiple users are involved, each plot input may be directed toward the same character or toward differing characters, as desired by the individual user and as permitted by the range of recorded content and available plot branches. In the event of multiple users directing a single character, the inputs are aggregated in order to determine the proceeding plot branch. Should a tie occur, either a revote can occur or else one of the users can be designated as the tie-breaker in order to choose the appropriate branch and proceed with the storyline.

As will be appreciated by those of ordinary skill in the art, plots and/or subplots (and commensurately branches and/or sub-branches) need not be binary—there can be many sub-plots or branches/sub-branches emanating from a single initial plot device (as can be typical when an audio/visual event commences)—though multiple initiating plot devices and/or starting points is not beyond the ambit of the subject application. Moreover, the many different and differentiable plot and subplot devices and therefore the multiplicity of emanating branches and sub-branches can be representative of character-driven choices—where an actor playing the part of the character in the audio/visual broadcast event selects from a plethora of possible courses of action.

The courses of action, in accordance with embodiments described herein, can be based on user/viewer input solicited during, for example, a live broadcast event, and in collaboration with an aggregation facility, wherein multiple users can be polled and the most popular plot scenario(s), in addition to the nominal plot, can be displayed for the actor to perform (e.g., either through pre-established (pre-written) script(s) and/or by actor improvisation). In this manner, either through a remote control functionality associated with a user device (e.g., tablet computing devices, handheld devices, server class computing devices, machines and/or databases, laptop computers, notebook computers, desktop computers, cell phones, smart phones, consumer appliances and/or instrumentation, set-top boxes, server boxes, client boxes, and/or components, industrial devices and/or components, hand-held devices, personal digital assistants, multimedia Internet enabled phones, multimedia players, consumer and/or industrial appliances and/or instrumentation associated with automotive vehicles, industrial and/or consumer appliances and/or instrumentation associated with aerospace vehicles and/or satellites, and the like) or a dedicated selection facility device, individual audience members can decide what decisions multiple characters make at various pivotal junctions within the audio/visual broadcast event. As will be appreciated by those of ordinary skill, this facility can be disabled if necessary or desired, and a nominal plot line can be taken for an entirely passive experience. When enabled however, the ability to interact and/or make directive decisions for the characters can occur at defined time periods (e.g., every five (5) to ten (10) minutes, every half an hour, before an impending advertising/commercial break, immediately after an advertising/commercial break, . . . ).

The subject disclosure enables viewers to be active participants in their television entertainment experience. Whereas previously, audience members were unable to affect the course of events in a broadcast audio/visual entertainment event, the subject disclosure enables audience members to alter the possible ending(s) from a nominal ending, and thus create more or less favorable plot progressions and/or outcomes for the characters.

The subject disclosure provides facilities for both prerecorded audio/visual events, as well as live broadcast events, in a crowd-sourced aggregated manner. For instance, competitors in adventure or strategy type of reality broadcast events can make choices as a function of, in response to, or based on how the audience votes. A similar type of audience feedback can also be employed for contestants in game shows, acting as proxies for the various sets or subsets of the viewing audience. In the context of “sets” and/or “subsets”, as intended and used in this disclosure, these terms imply non-empty sets, sets with at least one member, and/or not a null set.

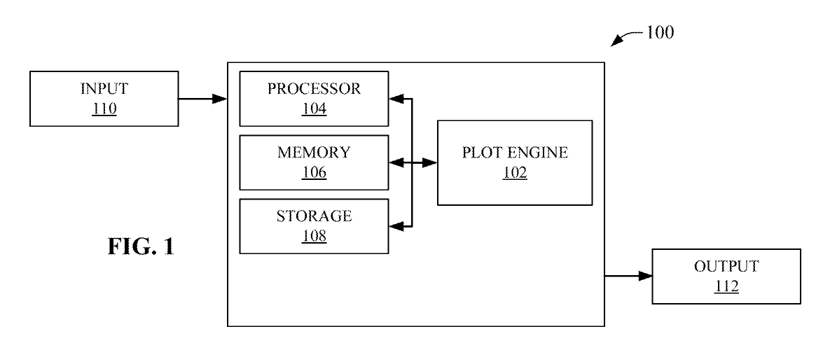

With reference to FIG. 1 that illustrates a system 100 that in accordance with various embodiments enables passive audiences to become active participants in plot choices made by characters in audio/visual broadcast events. System 100 can comprise plot engine 102 that can be in operative communication with processor 104, memory, 106, and storage 108. Plot engine 102 can be in communication with processor 104 for facilitating operation of computer or machine executable instructions and/or components by plot engine 102, memory 106, for storing data and/or the computer or machine executable instructions and/or components, and storage 108 for providing longer term storage of data and/or machine and/or computer readable instructions. Additionally, system 100 can also receive input 110 for use, manipulation, and/or transformation by plot engine 102 to produce one or more useful, concrete, and tangible result(s), and/or transform one or more articles to different states or things. Further, system 100 can also generate and output the useful, concrete, and tangible results and/or the transformed one or more articles as output 112.

System 100, for purposes of elucidation, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing machines and/or databases, laptop computers, notebook computers, desktop computers, cell phones, smart phones, consumer appliances and/or instrumentation, industrial devices and/or components, hand-held devices, personal digital assistants, multimedia Internet enabled phones, multimedia players, consumer and/or industrial appliances and/or instrumentation associated with automotive vehicles, set-top boxes, server boxes, client boxes, and/or components, industrial and/or consumer appliances and/or instrumentation associated with aerospace vehicles and/or satellites orbiting in low earth orbit, geosynchronous orbit, and the like.

In accordance with an embodiment plot engine 102 can download/upload or stream, as output 112, an initial section of content representing a broadcast event and a first index of subsequent first subsections of content that follow the initial section of content to a remote storage device associated with a display device associated with an end user device, such as a laptop computing device, tablet computing device, handheld device, notebook computer device, desktop computer device, cell phone device, smart phone device, consumer appliance, industrial device, multimedia Internet enabled phone, multimedia player devices, and the like. The initial section of content can, for example be the opening scenes of a audiovisual entertainment event, such as a television novella, soap opera, action thriller, political drama, etc. The commencing scenes to the audiovisual entertainment event can be a common starting-off point for the ensuing audiovisual entertainment event. However, as has been noted earlier, the subject disclosure is not so limited, as multiple disparate starting-off or initiating points are also contemplated to fall within the ambit of the subject disclosure.

Plot engine 102, as a function of an elapse of time equaling or exceeding a defined time threshold, can facilitate prompting of an audience member to select, based on the downloaded first index, a subsequent subsection of content from the subsequent first subsections of content for display on a display device associated with a user device. For instance, plot engine 102 can facilitate the display of a prompt (or sequence of prompts) on the display device requesting the audience member to select a plot device from a plurality of proposed plot devices that can have been scripted to move the audio/visual event forward to a conclusion. For example, the prompt can be whether the audience member(s) wish for our heroine, Harlyn, to: leave her abusive husband, Dastardly; stay with Dastardly; abscond with the brazen Mustachio; or inform feckless Police Constable Pistachio of the abuse that she is suffering at the hands of Dastardly. Further, timing for initiating display of the prompt(s) can be based on a defined time threshold being equaled or exceeded since the display of previous prompts. Additionally, the display of prompts can be initiated just before an impending advertising/commercial break/intermission in the audio/visual event, immediately following an advertising/commercial break in the audio/visual event, or where there is a natural break in the scripted audio/visual event (e.g., at the conclusion of an act in the audio/visual event).

Plot engine 102, based on a response by the audience member to the prompting, can receive an index value representative of the subsequent subsection of content that has been selected by the audience member. In accordance with an embodiment, the index value representative of the subsequent subsection of content can be a value that represents a hierarchy of branches and/or sub-branches related to the audio/visual event. For example, a value representative of the hierarchy of branches and/or sub-branches can be “1.4.9”, which when read from left to right, indicates that at the commencement of the audio/visual event a first plot branch (e.g., 1) was selected (or since this is the commencement of the audio/visual event, the first plot branch could have been selected to initiate the audio/visual event, though as has been noted earlier, this is not necessarily the case when there are multiple different initiating plots (an initial plurality of plot branches) that can commence or initiate the audio/visual event), thereafter the fourth branch (e.g., 4) of a first plurality of plot branches was selected, and then the ninth sub-branch (e.g., 9) of a second plurality of plot branches is now being selected. Continuing with the illustration, at a future juncture in time (e.g., when the elapsed time next equals or exceeds the defined time threshold), the audience member can select the twenty-fourth branch of a third plurality of plot branches for playback on the display device, in which case the hierarchy of branches and/or sub-branches can be represented as “1.4.9.24”. In this manner the audio/visual event can proceed to a satisfactory conclusion (or based on the progression of branches and sub-branches selected to one of many possibly disparate satisfactory alternate/alternative conclusions).

Plot engine 102 having received an input from the audience member representing an index value representative of the subsequent subsection of content selected, can employ or use the index value to facilitate downloading of the identified content to a storage facility associated with the user device on which the audio/visual event is being streamed and/or viewed.

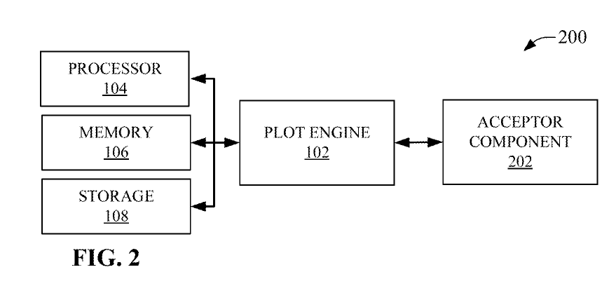

FIG. 2 provides additional depiction of system 100, now illustrated as system 200, in accordance with one or more various embodiments. System 200 can include acceptor component 202 that in collaboration with plot engine 102, processor 104, memory 106, and/or storage 108 can determine, as measured by a system clock (such as a non-specific, generic countdown timer, watchdog timer, a specifically designated and configured countdown timer, a bespoke watchdog timer, and the like) whether or not there has been an expiration of a defined time period, at which point acceptor component 202 can facilitate the display of a prompt, on a display device associated with a user device, of a listing of subplot elements that follow a currently playing plot element, wherein the subplot elements and the currently playing plot element represent a live broadcast audio/visual event. Acceptor component 202 can then receive a response to the prompt from a user device, wherein the response, based on the displayed listing of subplot elements, represents a selection by a user of a subplot element from the displayed subplot elements. Thereafter, acceptor component 202, based at least in part on the subplot element selected, can download the selected subplot element together with a further listing of subplot elements that can follow the selected subplot element. It should be noted that the listing of subplot elements can be represented as an index of values that can represent the pluralities of plots and subplots associated with the live broadcast audio/visual event.

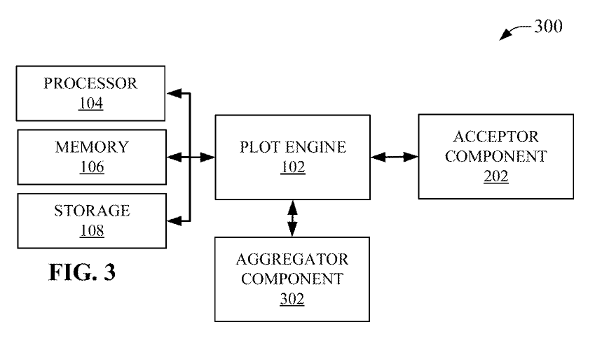

FIG. 3 provides additional illustration of system 100, now depicted as system 300 in accordance with additional example embodiments. System 300 can include aggregator component 302 that can operate in collaboration with acceptor component 202, plot engine 102, processor 104, memory 106, and storage 108, wherein in response to receiving second input from a second user device, aggregator component 302 aggregates the received second input with first input received from a first user device, wherein the first input can have been received earlier from the first user device. Aggregator component 302 thereafter can determine whether a defined period of time has expired or whether or not the effluxion of time has equaled or exceeded a defined threshold. Where aggregator component 302 determines that the defined period of time has expired or that the effluxion of time equals or exceeds a defined threshold, aggregator component 302 can facilitate downloading of a plot of a plurality of plots and/or a subplot of a plurality of subplots to a storage device associated with a display device, wherein the plot of the plurality of plots and/or the subplot of the plurality of subplots is selected based on or as a function of the aggregation maintained by aggregator component 302, each plot of the plurality of plots and/or each subplot of the plurality of subplots can be respectively identified by a unique index number, and wherein each subplot of the plurality of subplots is a continuation of each plot of the plurality of plots (e.g., each subplot branch of the plurality of subplot branches is capable of descending from each plot point in the plurality of plot points).

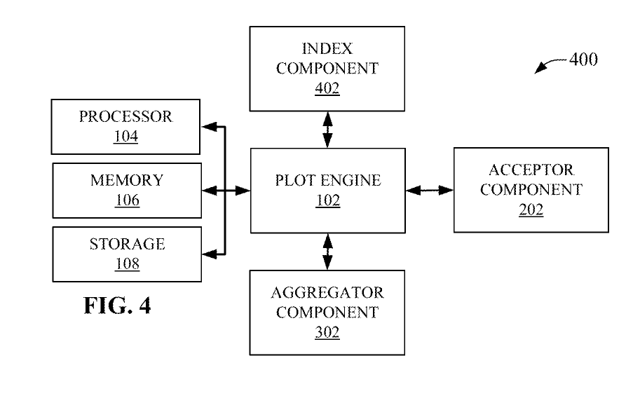

FIG. 4 provides further depiction of system 100, now depicted as system 400, in accordance with one or more various embodiments. As illustrated system 400 can include index component 402 that in conjunction with plot engine 102, acceptor component 202, aggregator component 302, processor 104, memory 106, and storage 108 receives input representing a first index value representative of a subplot of first subplots, and based on or in response to the received input, determines a grouping of second subplots that are successive in sequence to the subplot of the first subplot, wherein the grouping is represented as an index of values. Index component 402 can thereafter download the subplot of the first subplots and the index of values representative of the grouping of second subplots to a storage/persistence medium associated with a user device.

In the context of the foregoing described index of values representative of various groupings of plots, subplots, and/or sub-subplots, the index of values can be represented as: “2.49.23”, which indicates that there are twenty-three (23) sub-subplots emanating from the forty-ninth subplot (49), which emanated from the second plot sequence (2). Additionally and/or alternatively, the index of values representative of the various branching, sub-branching, and/or sub-sub-branching associated with the audio/visual broadcast event can be formed by applying a cryptographic hash function (e.g., secure hash algorithm 0 (SHA-0), secure hash algorithm 1 (SHA-1), secure hash algorithm 2 (SHA-2), secure hash algorithm 3 (SHA-3), MD5, and the like) or a format-preserving cryptographic function to each of the plots, sub-plots, and sub-subplots to obtain a unique value that can be associated with each respective plot, subplot, and/or sub-subplot. Through application of a cryptographic hash function and/or a format-preserving cryptographic function to the plots, sub-plots, and/or sub-subplots, not only is a unique index value provided to each plot, sub-plot, and/or sub-subplot sequence that can comprise an audio/visual event, but the digital rights and intellectual property associated with the entirety of the audio/visual event can be preserved.

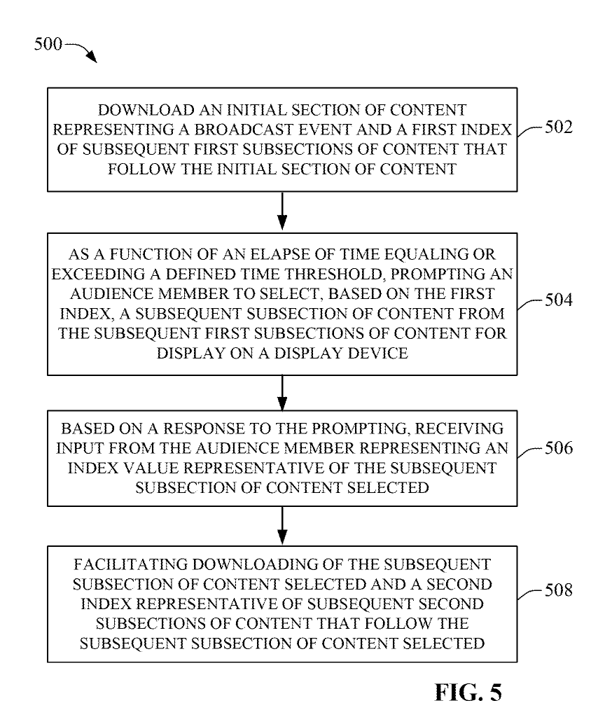

In view of the example system(s) described above, example method(s) that can be implemented in accordance with the disclosed subject matter can be better appreciated with reference to the flowcharts in FIGS. 5-8. For purposes of simplicity of explanation, the example method disclosed herein is presented and described as a series of acts; however, it is to be understood and appreciated that the disclosure is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, the disclosed example method can be implemented in combination with one or more other methods, to accomplish one or more aspects herein described. It should be further appreciated that the example method disclosed throughout the subject specification are capable of being stored on an article of manufacture (e.g., a computer-readable medium) to allow transporting and transferring such methods to computers for execution, and thus implementation, by a processor or for storage in memory.

FIG. 5 illustrates a method 500 for enabling passive audiences to become active participants in plot choices made by characters in audio/visual broadcast events. Method 500 can commence at 502 where an initial section of content representing an audio/visual broadcast event and a first index of subsequent first subsections of content that follow the initial section of content can be downloaded. At 504, as a function of an elapse of time equaling or exceeding a defined time threshold, an audience member can be prompted to select, based on the first index, a subsequent subsection of content from the subsequent first subsections of content for display on a display device, wherein the subsequent subsection of content represents further content in the audio/visual broadcast event. At 506, based on a response from the audience member, input from the audience member representing an index value representative of the subsequent subsection of content selected can be received. At 508, the subsequent subsection of content selected based on the index value and a second index representative of subsequent second subsections of content that follow the subsequent subsection of content can be downloaded to a user device comprising a storage device and/or a display device.

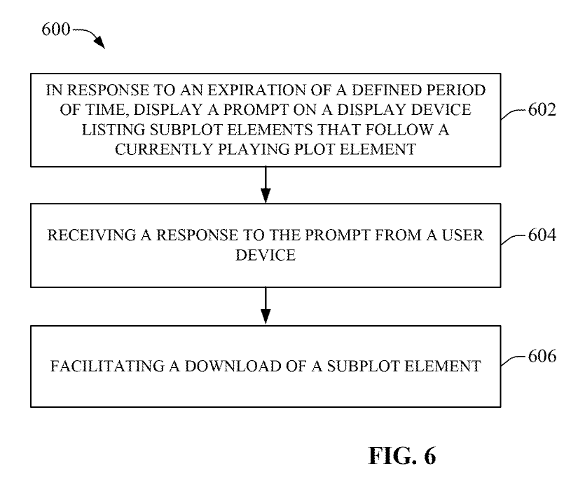

FIG. 6 depicts a method 600 for enabling passive audiences to become active participants in plot choices made by characters in audio/visual broadcast events. Method 600 can commence at 602 where, in response to an expiration of a defined period of time, a prompt can be displayed on a display device listing subplot elements that follow a currently playing plot element. At 604, a response to the prompt can be received from a user, and at 606, based on the response from the user a subsequent plot element can be downloaded to a storage device.

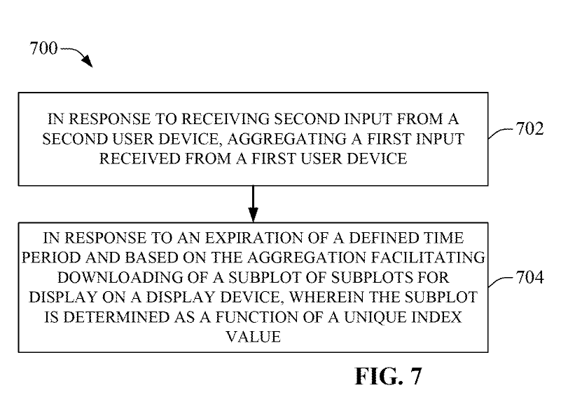

FIG. 7 illustrates a method 700 for enabling passive audiences to become active participants in plot choices made by characters in audio/visual broadcast events. Method 700 can commence at 702 where, in response to receiving second input from a second user device, a first input received from a first user device can be aggregated with the second input. At 704, in response to an expiration of a defined time period and based on the aggregation of the first input and the second input, a subplot of subplots for display on a display device can be downloaded. The subplot of subplots can have been determined as a function of a unique index value.

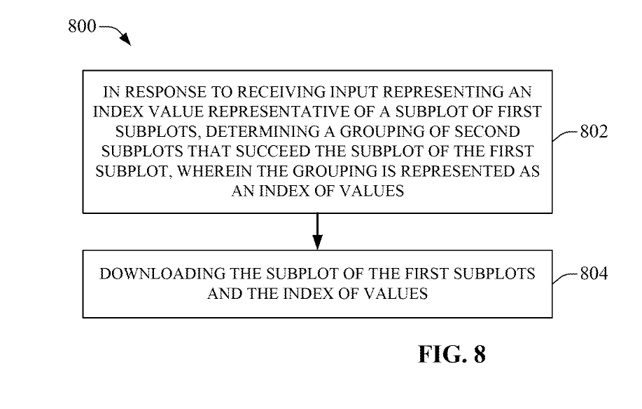

FIG. 8 depicts a method 800 for enabling passive audiences to become active participants in plot choices made by characters in audio/visual broadcast events. Method 800 can commence at 802 where, in response to receiving input representing an index value representative of a subplot of first subplots, a grouping of second subplots can be determined that succeed the subplot of the first subplots, wherein the grouping is represented as an index of values. At 804, the subplot of the first subplots and the index of values can be downloaded to a storage device.

It should be realized and appreciated by those of ordinary skill, the foregoing non-limiting example use application(s) are merely illustrations of a use to which the disclosed and described solution can be applied and thus are provided solely for the purposes of exposition. The described and disclosed subject matter is therefore not limited to the foregoing example application(s), but can find applicability in other more generalized circumstances and use applications.

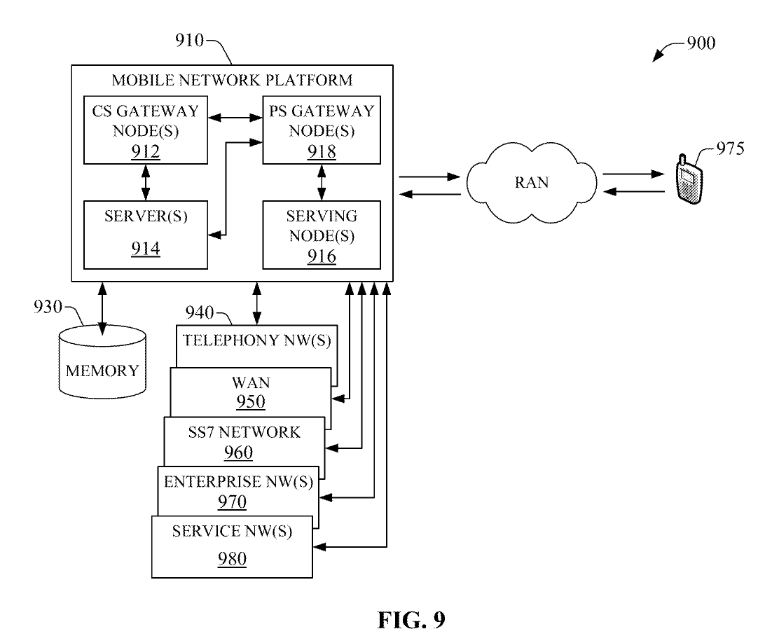

FIG. 9 presents an example embodiment 900 of a mobile network platform 910 that can implement and exploit one or more aspects of the disclosed subject matter described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, and can be considered carrier-side components as discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 970; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 960 can embody, at least in part, a service network(s) like IP multimedia subsystem (IMS). Based on radio technology layer(s) available in technology resource(s), packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s), convey the various packetized flows of data streams received through PS gateway node(s) 918. It is to be noted that for technology resource(s) that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload radio access network resources in order to enhance subscriber service experience within a home or business environment by way of UE 975.

It is to be noted that server(s) 914 can include one or more processors configured to confer at least in part the functionality of mobile network platform 910. To that end, the one or more processors can execute code instructions stored in memory 930, for example.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 960, or SS7 network 970. In this aspect, memory 930 can, for example, be accessed either as part of a data store component or else as a remotely-connected memory store.

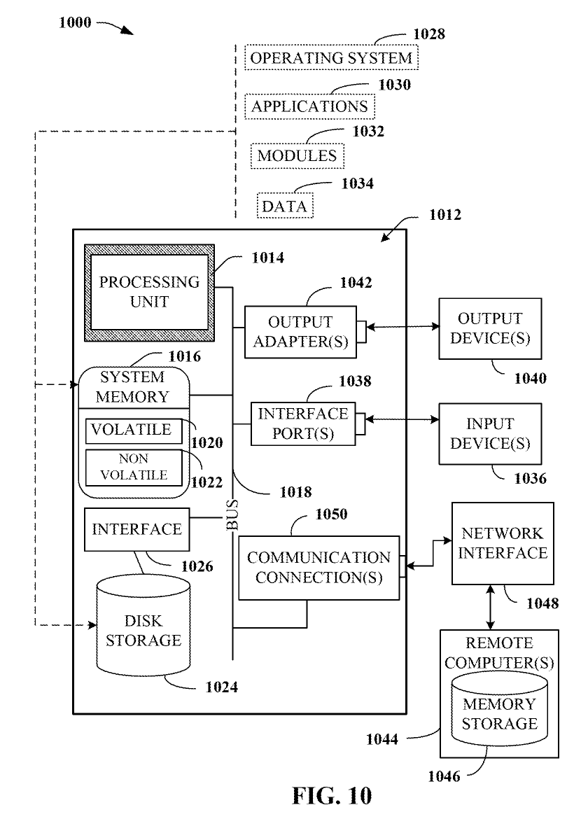

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read-only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of the hardware of system 100, includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MS A), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1016 can include volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, a mobile device and/or portable device can include a user interface embodied in a touch-sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider-enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices, and drawings, such terms are intended to be inclusive in a manner similar to the term “comprising” as “comprising” is interpreted when employed as a transitional word in a claim.

1. A first device, comprising:
a processor; and
a memory that stores executable instructions that, when executed by the processor, facilitate performance of operations, comprising:
facilitating a first download, to a user device, of an initial section of broadcast audiovisual content and index data representative of an index representing subsequent subsections of the broadcast audiovisual content, wherein a subsection of the subsequent subsections is represented by a numerical value representative of a value that maps a plot choice to the subsection within the subsequent subsections and a location of the plot choice within a hierarchical structure representative of the broadcast audiovisual content, wherein the index data is determined as a function of a format preserving function that maintains a format associated with the numerical value, and wherein the numerical value is an alphanumeric string of a fixed length and a length of the index data is equal to the fixed length;
facilitating a display of a prompt as a function of the index data; and
based on a reply received from the user device in response to the prompt, facilitating a second download of a subsequent subsection of the subsequent subsections for display by the user device.

2. The first device of claim 1, wherein the plot choice is a plot device, and wherein the prompt represents the plot device that furthers the broadcast audiovisual content from the initial section to the subsequent subsection of the subsequent subsections of the broadcast audiovisual content.

3. The first device of claim 2, wherein the prompt that represents the plot device is displayed as a function of a defined time period being exceeded.

4. The first device of claim 2, wherein the prompt that represents the plot device is displayed in response to an elapse of time exceeding a threshold value.

5. The first device of claim 2, wherein the prompt that represents the plot device is displayed during a scheduled commercial intermission during a streaming of the broadcast audiovisual content.

6. The first device of claim 2, wherein the prompt that represents the plot device is displayed at a commencement of a scheduled commercial intermission during a streaming of the broadcast audiovisual content.

7. The first device of claim 2, wherein the prompt that represents the plot device is displayed at a conclusion of a scheduled commercial intermission during a streaming of the broadcast audiovisual content.

8. The first device of claim 2, wherein the prompt that represents the plot device is a second prompt and is displayed as a function of an elapse of a defined time period since a display of a first prompt representing a previous plot device associated with the broadcast audiovisual content.

9. The first device of claim 1, wherein the index data represents a value obtained by applying a hash function to the subsequent subsections of broadcast content.

10. The first device of claim 9, wherein the hash function is a cryptographic hash function that generates a unique value.

11. The first device of claim 1, wherein the format preserving function is a cryptographic hash function that generates a unique value.

12. The first device of claim 1, wherein the operations further comprise, in a response to the prompt, receiving an index value representative of the subsequent subsection of the subsequent subsections of the broadcast audiovisual content.

13. The first device of claim 12, wherein the index value represents a branch of a hierarchy of branches associated with the subsection of subsequent subsections of the broadcast audiovisual content.

14. A method, comprising:
streaming, by a system comprising a processor, an initial section of a broadcast of a live event and an index representing subsequent subsections of the live event, wherein a subsection of the subsequent subsections is represented as a unique numerical value representative of a plot selection associated with the subsection and a location of the plot selection within a hierarchy representative of the live event, wherein the index is determined as a function of a format preserving function that maintains a format associated with the unique numerical value, and wherein the unique numerical value is an alphanumeric string of a fixed length and a length of the index is equal to the fixed length;
facilitating, by the system, display of a prompt as a function of the index; and
based on input received from a device in response to the prompt, streaming, by the system, the subsequent subsection of the live event.

15. The device of claim 14, wherein the plot selection is a plot device, and wherein the prompt represents the plot device that furthers the live event from the initial section to the subsequent subsection of the subsequent subsections of the live event.

16. The device of claim 15, wherein the prompt representing the plot device is displayed as a function of a defined time period being exceeded.

17. The device of claim 15, wherein the prompt representing the plot device is a second prompt and is displayed as a function of an elapse of a defined time period since a display of a first prompt representing a previous plot device associated with the live event.

18. The device of claim 14, wherein the index represents a value obtained by applying a hash function to the subsequent subsections of the live event.

19. A non-transitory machine-readable storage medium, comprising executable instructions that, when executed by a processor, facilitate performance of operations, comprising:
streaming an initial section of a broadcast of a live event and index data comprising an index representing subsequent subsections of the live event subsequent to the initial section;
facilitating a display of a prompt as a function of the index data; and
based on a reply received from a device in response to the prompt, streaming a subsequent subsection of the subsequent subsections of the live event, wherein the subsection is represented as a numerical value that maps the subsection to a plot selection and a relative location of the plot selection within a hierarchy of branches representative of the live event, wherein the index data is determined as a function of a format preserving function that maintains a format associated with the numerical value, and wherein the numerical value comprises an alphanumeric string of a fixed length and a length of the index data is equal to the fixed length.

20. The non-transitory machine-readable storage medium of claim 19, wherein the operations further comprise, in a response to the prompt from the device, receiving an index value representative of the subsequent subsection of the subsequent subsections of the live event and wherein the index value represents a branch of the hierarchy of branches associated with the subsequent subsection of the subsequent subsections of the live event.
